(19) United States
(12) Patent Application Publication
(10) Pub. No.: US 2007/0225466 A1
(43) Pub. Date: Sep. 27, 2007

(54) Curable organometallic composition, organometallic polymer material and optical component

(75) Inventors: Mitsuaki Matsumoto, Hirakata-city (JP); Keiichi Kuramoto, Kadoma-city (JP); Nobuhiko Hayashi, Osaka-city (JP); Masaya Nakai, Hirakata-city (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi-city (JP)

(21) Appl. No.: 11/713,611

(22) Filed: Mar. 5, 2007

(30) Foreign Application Priority Data
Mar. 27, 2006 (JP) JP2006-086025
Sep. 29, 2006 (JP) JP2006-267255

(51) Int. Cl. C08G 77/04; C08L 83/04

(52) U.S. Cl. 528/25

(57) ABSTRACT

A curable organometallic composition containing an organometallic polymer having an -M-O-M- bond (M denotes a metal atom) and an aryl group, and a fluorene-based compound having an acryloyl or methacryloyl group, an organometallic polymer obtained by curing the composition and an optical component using the material.

### BACKGROUND OF THE INVENTION

1. Technical Field

The present invention relates to a curable organometallic composition useful for substrates for electrical wiring; machine part materials; various coating materials such as antireflection coatings and surface protection coatings; optical communication devices such as optical transmitter and receiver modules and optical switches; optical propagation path structures such as optical waveguides, optical fibers and lens arrays and optical devices including those structures such as optical beam splitters; display devices (displays, liquid crystal projectors and the like) related optical elements such as integrator lenses, microlens arrays, reflectors, light guides and projection screens; lenses for use in eyeglasses, CCD optical systems, digital still cameras and mobile telephone cameras; optical filters, diffraction gratings, interfero-meters, optical couplers, optical multiplexers and demultiplexers, optical sensors, holographic optical elements and other optical components; photovoltaic elements; contact lenses; medical artificial tissues; mold materials for light emitting diodes (LED); and the like. The present invention also relates to an organometallic polymer material obtained via curing of the composition.

2. Description of Related Art

Glass and plastic have been primary materials for lenses and other optical elements. Glass is rich in types and shows a wide variation of optical properties, which eases optical design. Also, its inorganic nature makes it highly reliable. Further, it can be made into a high-precision optical element by polishing.

However, glass is very expensive. If an aspherical shape other than flat and spherical shapes is to be given to glass, a special polishing machine must be employed, or alternatively, a glass material deformable in a low temperature must be shaped in an expensive, highly heat-resistant mold (made such as of a ceramic), i.e., shaped by a so-called molding method. This pushes up a fabrication cost.

In contrast, an optical element using a synthetic resin material (plastic material) can be fabricated inexpensively by injection molding or casting. This however creates problems including low heat-resistance, high thermal expansion, narrow selection range of optical properties such as a refractive index and low reliability.

As a measure to solve such problems, composite optical elements have been proposed which are contemplated to obtain desired properties by superimposing a resin layer on a glass base. Japanese Patent Laid-Open No. Sho 54-6006 discloses a low-pass filter which carries an organic polymer layer on a flat glass base. Japanese Patent Laid-Open Nos. Sho 52-25651 and Hei 6-222201 disclose a so-called, composite aspherical lens which carries an aspherically-shaped resin layer on a glass lens base.

Because the composite aspherical lens has a thinner resin portion, measuring about several hundreds micrometers, than a resin lens, it is characterized as undergoing a smaller shape change under the influence of temperature compared to the resin lens. The composite aspherical lens, if contemplated for use in a mobile telephone or a liquid crystal projector, is required to exhibit a high environment resistance, e.g., withstand a heat at about 150° C.

In order to achieve a throughput improvement in the process of transferring a resin layer onto a glass lens by a mold, a photocurable resin is preferably used to form the resin layer.

If the device is to be reduced in size and thickness, the resin itself must be increased in refractive index. At the same time, its volumetric cure shrinkage upon photocuring must be sufficiently low to precisely transfer a mold shape.

There is a method for increasing an index of refraction of a resin by mixing high-refractive, fine oxide particles in the resin. International Publication No. WO 2002/088255 discloses a resin composition using alkoxysilane, metal oxide particles and an acrylic resin. In International Publication No. WO 2002/088255, anorganic-inorganic hybrid polymer material made using alkoxysilane as a raw material is described as being superior in heat resistance. However, neither the cure shrinkage nor the heat resistance required for the composite aspherical lens is specifically disclosed.

Japanese Patent Laid-Open No. Hei 4-325508 discloses a high-refractive resin for a plastic lens, which is obtained by dissolving a solid fluorene-based acrylate in a vinyl compound monomer such as an acrylate monomer and then exposing the resultant to heat or light so that it is cured via radical polymerization.

However, the vinyl compound used to dissolve the solid, such as an acrylate monomer, exhibits a significant volumetric cure shrinkage of about 8-10% during polymerization. This reduces molding precision. Also, a problem arises when this resin is used to form a resin layer on a glass or other base in the fabrication of a composite aspherical lens. Due to the shrinkage, the resin layer is separated from the substrate.

A lens composed entirely of a plastic, such as the one disclosed in Japanese Patent Laid-Open No. Hei 4-325508, avoids the problem of separation. A precision requirement of the eyeglass lens disclosed in Japanese Patent Laid-Open No. Hei 4-325508 is about several tens micrometers. In terms of dimensional precision, it sets a standard at least a figure lower than the precision requirement (about 1 μm) for mobile telephones and digital cameras using a CCD or CMOS sensor.

As described above, in the current state of the art, a resin for optical component has not been obtained to date which can simultaneously satisfy the low cure shrinkage, high refractive index, heat resistance, photocuring ability and transparency (tendency to prevent light scattering due to clouding) required for composite aspherical lenses for use such as in mobile telephones mounting compact-type and slim-type cameras.

### SUMMARY OF THE INVENTION

It is an object of the present invention to provide a curable organometallic composition which shows a low volumetric cure shrinkage and, after cured, exhibits a high refractive index and superior heat resistance, and also provide an organometallic polymer material obtained as a result of curing of the composition and an optical component using the polymer material.

The curable organometallic composition of the present invention is characterized as containing an organometallic polymer having an -M-O-M- bond (M denotes an metal atom) and an aryl group, and a fluorene-based compound having an acryloy or methacryloyl group.

The organometallic polymer in the present invention has an aryl group. Overlapping of n electron clouds of this aryl group and the aryl group in the fluorene-based compound creates a binding force by which an affinity between the organometallic polymer and the fluorene-based compound is enhanced. This prevents the organometallic polymer and the fluorene-based compound from being separated from each other, resulting in obtaining increased transparency.

In the present invention, a volumetric shrinkage can be reduced as a result of mixing the organometallic polymer in the fluorene-based compound. The increased affinity between the organometallic polymer and the fluorene-based compound, as described above, allows optional selection of a blending ratio thereof. Accordingly, the volumetric cure shrinkage can be held substantially constant at a low value, even if the blending ratio is varied.

Also in the present invention, both the organometallic polymer and the fluorene-based compound have an aryl group. Accordingly, the composition, when cured, exhibits a high refractive index and superior heat resistance.

Also in the present invention, a refractive index of the composition after curing can be controlled by varying a blending ratio of the organometallic polymer and the fluorene-based compound. Accordingly, even if the blending ratio of the organometallic polymer and the fluorene-based compound is varied, a volumetric cure shrinkage of the composition can be held at a low value, as described above, resulting in the curable organometallic composition which shows a low volumetric cure shrinkage and, when cured, exhibits a high refractive index.

The organometallic polymer material of the present invention is a cured product of the curable organometallic composition and can be obtained by polymerizing the curable organometallic composition of the present invention.

In the present invention, M in the -M-O-M- bond is preferably at least one of Si, Nb, Ti and Zr. It is particularly preferred that M is Si. In case M is Si, the organometallic polymer can be produced from a silicone resin.

The organometallic polymer in the present invention can be synthesized via hydrolysis and polycondensation of an organometallic compound having at least 2 hydrolyzable groups, for example. In case M is Si, such an organometallic compound can be illustrated by trialkoxysilane and dialkoxysilane which both contain an organic group. Examples of organic groups include alkyl, aryl and aryl-containing groups. The use of the organometallic compound having an aryl or aryl-containing group allows introduction of the aryl group in the organometallic polymer. The preferred aryl group is a phenyl group. Examples of organometallic compounds having a phenyl group include phenyltrialkoxysilane and diphenyldialkoxysilane, and more specifically, phenyltriethoxysilane, phenyltrimethoxysilane, diphenyldimethoxysilane and diphenyldiethoxysilane.

Also, the organometallic compound preferably has a functional group which crosslinks upon exposure to heat and/or energy radiation. In this case, exposure of the organometallic compound to the heat and/or energy radiation induces formation of links between its molecules and between the organometallic polymer and fluorene-based compound, so that the organometallic composition is cured to produce the organometallic polymer material of the present invention.

The energy radiation may be in the form of an ultraviolet radiation or an electron beam, for example. Examples of such crosslinking groups include (meth)acryloyl, styryl, epoxy, thiol and vinyl. Thus, trialkoxysilane or dialkoxysilane having any of these functional groups is preferably used. Specifically, the alkoxysilane having a (meth)acryloyl group can be illustrated by 3-methacryloxypropylmethoxysilane, 3-methacryloxypropyltriethoxysilane, p-styryltrimethoxysilane, p-styryltriethoxysilane, 3-acryloxypropyltrimethoxysilane, 3-methacryloxypropylmethyldimethoxysilane and 3-methacryloxymethacryloxypropylmethyldithoxysilane. The alkoxysilane having a vinyl group can be illustrated by vinyltriethoxysilane. The alkoxysilane having a thiol group can be illustrated by 3-mercaptopropylmethyldimethoxysilane and 3-mercapto-propyltrimethoxysilane.

Where a styryl group is used as the crosslinking group, the use of the organometallic compound having a styryl group allows introduction of an aryl group in the organometallic polymer.

In the case where the organometallic compound has a free-radically polymerizable group such as a (meth) acryloyl, styryl or vinyl group, the organometallic composition of the present invention preferably contains a free-radical polymerization initiator.

Examples of free-radical polymerization initiators include 1-hydroxy-cyclohexyl-phenyl-ketone, 2-hydroxy-2-methyl-1-phenyl-propane-1-one, 2-benzyl-2-dimethylamino-1-(4-morpholinophenyl)-butanone-1, oxy-phenyl-acetic acid-2-[2-oxo-2-phenyl-acetoxy-ethoxy]-ethyl-ester, oxy-phenyl-acetic acid-2-[2-hydroxy-ethoxy]-ethyl-ester and their mixtures.

In the present invention, where the organometallic compound having a crosslinking group is used in combination with an organometallic compound free of a crosslinking group, they are preferably blended in the ratio (organometallic compound having the functional group: organometallic compound free of the functional group) by weight of 5-95:95-5.

The fluorene-based compound useful in the present invention has an acryloyl or methacryloyl group. Such a fluorene-based compound can be illustrated by a fluorene-based (meth)acrylate having a 9,9-diphenylfluorene skeleton. A specific example of this fluorene-based acrylate is represented by the following general formula:

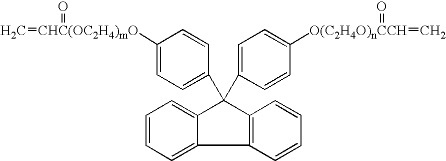

(in the formula, m and n are independently an integer of 0-5).

In the present invention, the (meth)acrylate is the term used to describe acrylate and methacrylate, collectively. The (meth)acryloyl is the term used to describe acryloyl and methacryloyl, collectively. Acryloxy is used equivalently in its meaning to acryloyl, while methacryloxy to methacryloyl.

When needed, a (meth)acrylate having only one functional group, i.e., a monofunctional (meth)acrylate may be added to the curable organometallic composition of the present invention for the purposes of adjusting a viscosity of a liquid before being cured by irradiation with energy radiation such as in the form of heat or light, mechanical properties such as a hardness and optical properties such as a refractive index and an Abbe number of the composition after cured. Alternatively, a polyfunctional (meth) acrylate having plural functional groups may be added.

Examples of monofunctional (meth)acrylates include benzyl (meth)acrylate, ethyl (meth)acrylate, methyl (meth)acrylate, isobornyl (meth)acrylate, cyclohexyl (meth)acrylate, dicyclopentyl (meth)acrylate, α-naphthyl (meth)acrylate, β-naphthyl (meth)acrylate, dicyclopentenyl-oxyethyl (meth)acrylate, bornyl (meth)acrylate and phenyl (meth)acrylate.

Examples of polyfunctional (meth)acrylates include bifunctional (meth)acrylates such as ethylene glycol di(meth)acrylate, propylene glycol di(meth)acrylate, polyethylene glycol di(meth)acrylate, polypropylene glycol di(meth)acrylate, 1,6-hexanediol di(meth)acrylate, glycerin di(meth)acrylate, di(meth)acrylate of 2,2-dimethyl-3-hydroxypropyl-2,2-dimethyl-3-propionate, 1,4-butanediol di(meth)acrylate, neopentyl glycol di(meth)acrylate, di(meth)acrylate of neopentyl glycol hydroxypivalinate, di(meth)acrylate of a propylene oxide adduct of bisphenol A, di(meth)acrylate of 2,2′-di(hydroxypropoxyphenyl)propane, di(meth)acrylate of 2,2′-di(hydroxyethoxyphenyl)propane, di(meth)acrylate of an ethylene oxide adduct of bisphenol A, di(meth)acrylate of dimethylol tricyclodecane and an adduct of 2,2′-di(glycidyloxyphenyl)propane with di(meth)acrylic acid. Other examples include pentaerithritol tri(meth)acrylate, pentaerithritol tetra(meth)acrylate, trimethylolpropane tri(meth)acrylate, dipentaerithritol hexa(meth)acrylate, tri(meth)acrylate of trimellitic acid, triallyl trimellitate, tri(meth)acrylate of triallylisocyanurate, tri(meth)acrylate of tris(2-hydroxyethyl)isocyanurate, tri(meth)acrylate of tris(hydroxypropyl)isocyanurate, tetramethylolmethane tri(meth)acrylate, tetramethylolmethane tetra(meth)acrylate and the like.

The curable organometallic composition of the present invention may further contain a (meth)acrylate having one or more aryl groups, if necessary. Examples of (meth)acrylates having one or more aryl groups include benzyl(meth)acrylate, phenoxyethyl(meth)acrylate, phenoxypropyl(meth)acrylate, acryloyloxyethyl phthalate, cresol(meth)acrylate, paracumyl phenoxy ethylene glycol(meth)acrylate, tribromophenyl(meth)acrylate, bisphenol-A di(meth)acrylate, bisphenol-F di(meth)acrylate, phthalic (meth)acrylate, trimethylol-propanebenzoate(meth)acrylate, naphthyl(meth)acrylate, and ethylene oxide addition (EO-modified) products, propylene oxide addition (PO-modified) products and ethylcyclohexane addition (ECH-modified) products thereof.

Also, the curable organometallic composition of the present invention may further contain an aromatic urethane acrylate oligomer. Examples of aromatic urethane acrylate oligomers include “Ebecryl 210” and “Ebecryl 220” available from Daicel-Cytec Co., Ltd., “Uvithanc 782” and “Uvithanc 783” available from Nomura Jimusho, Inc., and “Laromer LR8983” available from BASF, and products (e.g., “Ebecryl 205” available from Daicel-Cytec Co., Ltd.) obtained by diluting them with a (meth)acrylate such as tripropylene glycol diacrylate.

The curable organometallic composition of the present invention may further contain a metal alkoxide having only one hydrolyzable group and/or its hydrolysate. This metal alkoxide and/or its hydrolysate may be contained in the state of being either joined or unjoined to the organometallic polymer. The hydrolysate of the metal alkoxide may be in the form of a polycondensate of the hydrolysate.

The metal alkoxide having only one hydrolyzable group and/or its hydrolysate, when contained, reacts to —OH groups produced at molecular ends of the organometallic polymer so that those —OH groups disappear. This suppresses reduction of water absorption due to the presence of —OH groups and reduction of optical absorption in the 1,450-1,550 nm wavelength range, and also suppresses volumetric shrinkage that occurs as —OH groups in a high-temperature condition gradually condense with each other. Since such volumetric shrinkage causes separation of the resin layer and lowers precision, the suppression of volumetric shrinkage reduces the tendency of the resin layer to separate and prevents reduction of precision.

Examples of metal alkoxides having only one hydrolyzable group in the present invention include trimethylmethoxysilane, trimethylethoxysilane, triethylmethoxysilane, triethyl-ethoxysilane, tripropylmethoxysilane, tripropylethoxysilane, benzyldimethylmethoxysilane, benzyldimethylethoxysilane, diphenylmethoxymethylsilane, diphenylethoxymethylsilane, acetyltriphenylsilane and ethoxytriphenylsilane.

Preferably, the curable organometallic composition of the present invention further contains an organic acid anhydride and/or organic acid. Since the organic acid anhydride hydrolyzes upon absorption of water, inclusion thereof leads to a reduction in water content of the organometallic polymer. This suppresses reduction of optical absorption due to the presence of water and also prevents shape change that occurs due to evaporation of water.

The organic acid, if incorporated in the organometallic polymer, promotes a reaction of a silanol group or the like and thus promotes decomposition of the silanol group or the like. For example, the organic acid can also promote a reaction between silanol groups at molecular ends of the organometallic polymer. Also, a reaction is promoted in which a hydrolysate of the metal alkoxide having only one hydrolyzable group acts to an —OH group produced at a molecular end of the organometallic polymer to thereby decompose the —OH group.

Specific examples of organic acid anhydrides include trifluoroacetic anhydride, acetic anhydride and propionic anhydride. Use of trifluoroacetic anhydride is particularly preferred. Specific examples of organic acids include trifluoroacetic acid, acetic acid and propionic acid. Use of trifluoroacetic acid is particularly preferred.

The curable organometallic composition of the present invention preferably contains the organometallic polymer in the amount of 5-95% by weight, more preferably 20-75% by weight, further preferably 20-50% by weight. If the amount of the organometallic polymer is excessively small, the composition is brought closer in property to the fluorene-based compound. This increases a temperature dependency of its refractive index and subjects it to a larger shape change in a high-temperature environment. Further, a viscosity of the composition before cured is increased. This results in the difficulty for the composition to be formed with high precision, particularly in a mold, into a product measuring about 100 μm in thickness, which thickness is required for an optical component such as a composite aspherical lens. On the other hand, if the amount of the organometallic polymer is excessively large, a reduction in refractive index results.

The curable organometallic composition of the present invention preferably contains the fluorene-based compound in the amount of 5-95% by weight, more preferably 30-80% by weight. The refractive index shows a declining tendency if the amount of the fluorene-based compound is excessively small. In particular, the refractive index can be readily increased to 1.58 or above if the fluorene-based compound is contained in the amount of at least 25% by weight and to 1.59 or above if the fluorene-based compound is contained in the amount of at least 35% by weight. On the other hand, if the amount of the fluorene-based compound is excessively large, the composition is brought closer in property to the fluorene-based compound. This increases a temperature dependency of refractive index of the composition and subjects it to a larger shape change in a high-temperature environment. Further, a viscosity of the composition before cured is increased. This results in the difficulty for the composition to be formed with high precision, particularly in a mold, into an about 100 μm thick product, which thickness is required for an optical component such as a composite aspherical lens. In order that the viscosity of the composition is low enough to allow easy handling in room temperature, the amount of the fluorene-based compound is preferably kept not to exceed 70% by weight, more preferably 50% by weight.

The curable organometallic composition of the present invention may contain the monofunctional or polyfunctional (meth)acrylate, as described above. An upper limit of its amount is preferably within 40% by weight, more preferably within 30% by weight, further preferably within 25% by weight. A lower limit of its amount is preferably at least 5% by weight, more preferably at least 10% by weight, further preferably at least 15% by weight. The purpose of adding this (meth)acrylate is to adjust a viscosity of the composition, a hardness of the composition after cured, or the like. Accordingly, if its amount is excessively small, such viscosity adjustment or hardness adjustment of the composition after cured in some cases become insufficient. On the other hand, if such (meth)acrylate is excessively large in amount, the volumetric cure shrinkage of the curable organometallic composition may become excessively large due to a high cure shrinkage of the (meth)acrylate.

The curable organometallic composition of the present invention preferably contains the metal alkoxide having only one hydrolyzable group and/or its hydrolysate in the amount of 0.1-15 parts by weight, more preferably 0.2-2.0 parts by weight, based on 100 parts by weight of the organometallic polymer. The excessively small amount of the metal alkoxide or its hydrolysate permits OH groups to remain. This increases water absorption and light absorption in the 1,450-1,550 nm wavelength range and, as a result, increases a tendency of the composition to deteriorate. On the other hand, the excessively large amount of the metal alkoxide or its hydrolysate permits excess metal alkoxide or its hydrolysate to leave from the material in a high-temperature environment, possibly leading to the occurrence of cracking.

The curable organometallic composition of the present invention preferably contains the organic acid anhydride or organic acid in the amount of 0.1-10 parts by weight, more preferably 1-5 parts by weight, based on 100 parts by weight of the organometallic polymer. If the amount of the organic acid anhydride or organic acid is excessively small, hydrolysis of the metal alkoxide may not be promoted sufficiently. On the other hand, if the amount of the organic acid anhydride or organic acid is excessively large, excess organic acid anhydride or organic acid may leave from the material in a high-temperature environment, possibly leading to the occurrence of cracking.

Also, the curable organometallic composition of the present invention preferably contains fine particles composed of at least one of a metal, metal oxide and metal nitride. Preferably, such fine particles do not exceed 100 nm in size.

Examples of metals include gold, silver and iron.

Examples of metal oxides include silicon oxide, niobium oxide, zirconium oxide, titanium oxide, aluminum oxide, yttrium oxide, cerium oxide and lanthanum oxide. The use of silicon oxide, niobium oxide, zirconium oxide and titanium oxide, among them, is preferred.

Examples of metal nitrides include aluminum nitride, zirconium nitride and titanium nitride.

Addition of the fine particles having a lower refractive index allows a controlled reduction of refractive index of the organometallic polymer material. Also, inclusion of the fine particles having a higher refractive index allows a controlled rise of refractive index of the organometallic polymer material. Examples of metal oxide particles which can increase the refractive index of the organometallic polymer material include particles of niobium oxide (Nb₂O₅), zirconium oxide (ZrO₂) and titanium oxide (TiO₂). The fine particles which can reduce the refractive index can be illustrated by silicon oxide (SiO₂) particles.

Such fine particles are preferably contained in the range of 5-50% by weight, based on the total weight of the organometallic composition.

The curable organometallic composition of the present invention may contain an additive. Examples of such additives include light stabilizers such as HALS (hindered amine light stabilizer) and UV absorbers.

The organometallic polymer material of the present invention is a cured product of the curable organometallic composition of the present invention and can be obtained by polymerizing the curable organometallic composition.

The optical component of the present invention is characterized in that it has a light transmissive region formed using the organometallic polymer material of the present invention.

A specific example of the optical component of the present invention is the one which has a light transmissive region formed on a base such as a translucent glass, ceramic or plastic by using the organometallic polymer material of the present invention. In the case where thin optical components are fabricated, a high-refractive glass or high-refractive translucent ceramic may preferably be used as the base.

The optical component of the present invention can be illustrated by a composite aspherical lens. This composite aspherical lens is made by depositing a light transmissive region, in the form of a translucent resin layer, on a spherical lens such as of a glass.

Because the organometallic polymer material of the present invention is obtained by curing the curable organometallic composition of the present invention, a volumetric cure shrinkage is low. Accordingly, in the case where the curable organometallic composition is deposited, in the form of a layer, on a translucent base such as of a glass and then cured to form a light transmissive region, this light transmissive region is restrained from separating from the base, resulting in the provision of the adherent light transmissive region. Also because the organometallic polymer material of the present invention has a high refractive index and shows superior heat resistance, as described above, the use thereof results in the fabrication of a composite aspherical lens which also has a high refractive index and superior heat resistance.

The optical device of the present invention is characterized as including the optical component of the present invention. The optical device of the present invention can be illustrated by a camera module including the aforementioned composite aspherical lens. Such a camera module is applicable to mobile phones and back monitors for cars.

The optical device of the present invention can also be illustrated by projectors such as a liquid crystal projector and optical waveguides comprising a core layer and/or a cladding layer formed using the organometallic polymer material.

The optical device of the present invention can further be illustrated by optical communication devices such as optical switches, optical transmitter and receiver modules and optical couplers; display devices such as liquid crystal devices, plasma display devices, organic EL displays and projectors; image pickup modules such as digital cameras and other cameras, video cameras and other image pickup devices, CCD camera modules and CMOS camera modules; optical tools such as telescopes, microscopes and magnifying glasses; and the like.

As stated above, the curable organometallic composition of the present invention contains the organometallic polymer having an -M-O-M- bond and an aryl group, and the fluorene-based compound having an acryloy or methacryloyl group, shows a low volumetric shrinkage upon curing and, subsequent to curing, exhibits a high refractive index and superior heat resistance. Also, high transparency is attained. Further, the blending ratio of the organometallic polymer and the fluorene-based compound can be varied selectively to thereby control the optical properties such as a refractive index and an Abbe number of organometallic polymer material.

When the curable organometallic composition is converted via curing to the organometallic polymer material, the low volumetric shrinkage of the composition upon curing prevents separation of the resulting organometallic polymer material. This enables molding thereof with high precision.

### BRIEF DESCRIPTION OF THE DRAWINGS

FIG. 1 is a schematic sectional view which shows an exemplary process by which a composite aspherical lens, as one embodiment of the optical component of the present invention, is fabricated;

FIG. 2 is a schematic view which shows an apparatus for measurement of spherical aberration of the composite aspherical lens;

FIG. 3 shows mesh pattern images when observed using a glass spherical lens and the composite aspherical lens;

FIG. 4 is a graph which shows the organometallic polymer loading vs. volumetric cure shrinkage of the composition in Example 1 in accordance with the present invention;

FIG. 5 is a graph which shows the loading of the organometallic polymer in the composition vs. refractive index of the photocured composition in Example 1 in accordance with the present invention;

FIG. 6 is a graph which shows the Abbe number vs. refractive index at wavelength 589 nm of the organometallic polymer material in Example 1 in accordance with the present invention;

FIG. 7 is a graph which shows the organometallic polymer loading in the composition vs. temperature coefficient of refractive index of the cured composition in Example 1 in accordance with the present invention;

FIG. 8 is a schematic sectional view which shows an example of a conventional camera module;

FIG. 9 is a schematic sectional view which shows an embodiment of a camera module in accordance with the present invention;

FIG. 10 is a sectional view which shows a folding mobile telephone;

FIG. 11 is a sectional view which shows an embodiment of an optical waveguide in accordance with the present invention;

FIG. 12 is a sectional view which shows another embodiment of an optical waveguide in accordance with the present invention;

FIG. 13 is a sectional view which shows a further embodiment of an optical waveguide in accordance with the present invention;

FIG. 14 is a schematic sectional view which shows an example of a liquid crystal projector;

FIG. 15 is a schematic sectional view which shows an embodiment of a liquid crystal projector in accordance with the present invention;

FIG. 16 is a schematic sectional view which shows another embodiment of a liquid crystal projector in accordance with the present invention;

FIG. 17 is a sectional view which shows an embodiment of a composite aspherical lens in accordance with the present invention;

FIG. 18 is a schematic sectional view which shows an apparatus used to perform a thermal shock test in Example 14 in accordance with the present invention;

FIG. 19 is a graph which shows time intervals at which a sample is cyclically moved between a constant-temperature chamber at 85° C. and a constant-temperature chamber at −40° C. in the thermal shock test; and

FIG. 20 is a schematic sectional view which shows an embodiment of an optical transmitter and receiver module in accordance with the present invention.

### DESCRIPTION OF THE PREFERRED EXAMPLES

The present invention is below described in more detail by way of examples which are not intended to be limiting thereof.

### Example 1

A fluorene acrylate having the above-specified chemical structure (where, m=1 and n=1) was used as the fluorene-based compound.

(Viscous Liquid A)

10 g of the fluorene acrylate, 0.2 g of 1-hydroxy-cyclohexyl-phenylketone, 0.05 g of HALS (Tinuvin 292, product of Chiba Specialty Chemicals Inc.), 0.15 g of a U absorber (Tinuvin 400, product of Chiba Specialty Chemicals Inc.) and 1.43 g of benzyl methacrylate were mixed while heated at 60° C. to obtain a viscous liquid A.

(Viscous Liquid B)

15.3 ml of an organometallic compound A in the form of 3-methacryloxypropyltriethoxysilane, 6.3 ml of an organo-metallic compound in the form of diphenyldimethoxysilane, 3.8 ml of an aqueous solution containing hydrochloric acid (2N conc. hydrochloric acid) as a reaction catalyst and 40 ml of ethanol were mixed and then allowed to stand for 24 hours, during which time the organometallic compounds A and B were hydrolyzed and polycondensed.

The resulting liquid containing a polycondensate was placed under nitrogen atmosphere and heated to 100° C. to remove ethanol by evaporation. As a result, a viscous liquid was obtained. 1 g of this viscous liquid was collected and mixed with 3 ml of a metal alkoxide X in the form of trimethyl-ethoxysilane and 0.8 ml of anorganic acid Y in the form of trifluoroacetic anhydride. The resulting mixture was left to stand for 24 hours, placed under nitrogen atmosphere and then heat dried at 110° C. to remove excess metal alkoxide X and organic acid Y by evaporation. As a result, a viscous liquid B was obtained.

(Viscous Liquid C)

The viscous liquid A and the viscous liquid B in a predetermined ratio were mixed and stirred at 60° C. to obtain a viscous liquid C.

The viscous liquid C was introduced between a pair of 1 mm thick quartz glass plates and irradiated for 15 minutes with an ultraviolet lamp emitting an ultraviolet radiation of 365 nm center wavelength and about 30 mW/cm² intensity, so that the viscous liquid C was cured.

The volumetric shrinkage of the liquid composition upon curing, as well as the refractive index and Abbe number of the liquid composition after curing, were measured.

The specific gravity dL of the liquid composition before curing was measured according to 4.6.2 of JIS K 5400, the specific gravity dS of the liquid composition after curing was measured according to JIS Z 8807, and the volumetric cure shrinkage r was calculated from the following equation:

r=1−dL/dS.

The refractive index and Abbe number were measured using an Atago DR-M2 type Abbe refractometer manufactured by Atago Co., Ltd. The refractive index is given by a value measured at a d-line (589 nm) at 25° C.

A Metricon Model #2010 prism coupler manufactured by Metricon Corp. may be utilized to measure the refractive index and Abbe number.

### Comparative Example 1

The procedure of Example 1 was followed, with the exception that pentaerithritol triacrylate instead of the viscous liquid B containing the organometallic polymer was used, to cure the composition. The volumetric cure shrinkage, refractive index and Abbe number were measured in the same manner as in Example 1.

In Example 1 and Comparative Example 1, the organometallic polymer or pentaerithritol triacrylate was loaded in the amounts of 0% by weight, 20% by weight, 29% by weight, 50% by weight, 70% by weight and 100% by weight.

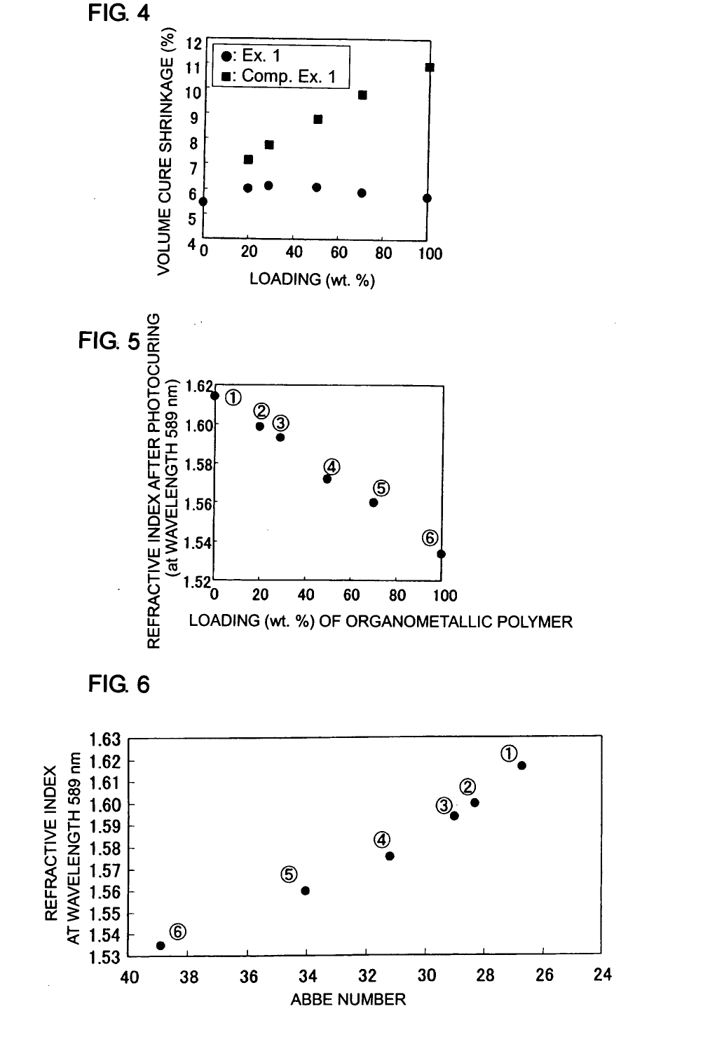

FIG. 4 is a graph which shows a relation of the loading of the organometallic polymer or pentaerithritol triacrylate to the volumetric cure shrinkage of the composition. In Example 1, the volumetric cure shrinkage is low in a 5-6% level, irrespective of the loading, and apparently little affected by the loading of the organometallic polymer (along the abscissa).

By contrary, in Comparative Example 1, the volumetric cure shrinkage exceeds 7% even when pentaerithritol triacrylate was loaded in the amount of 20% by weight. The higher loading further increases the volumetric cure shrinkage.

FIG. 5 is a graph which shows a relation of the loading of the organometallic polymer to the refractive index of the photocured composition. As shown in FIG. 5, the refractive index can be controlled widely over an approximate range of 1.53-1.61 by adjusting the loading of the organometallic polymer. Particularly when the organometallic polymer is loaded in the amount of 20% or 29% by weight, the photocured composition exhibits a refractive index of 1.59-1.60 and an Abbe number of not exceeding 30. These high refractive index and low Abbe number are comparable to those of a polycarbonate resin. Because the lower Abbe number increases the wavelength dependency of refractive index, construction of an optical system using a glass, resin or other optical material having a high Abbe number, in combination with the composition, enables correction of chromatic aberration.

FIG. 6 is a graph which shows a relation of the Abbe number to the refractive index at 589 nm of the organometallic polymer material obtained by curing the curable organometallic composition prepared in Example 1. As shown in FIG. 6, the refractive index of the material of Example 1 can be varied largely, as similar to the Abbe number. Accordingly, the use of the curable organometallic composition of the present invention affords broad freedom for the design of an optical device such as a camera module including a combination of plural lenses.

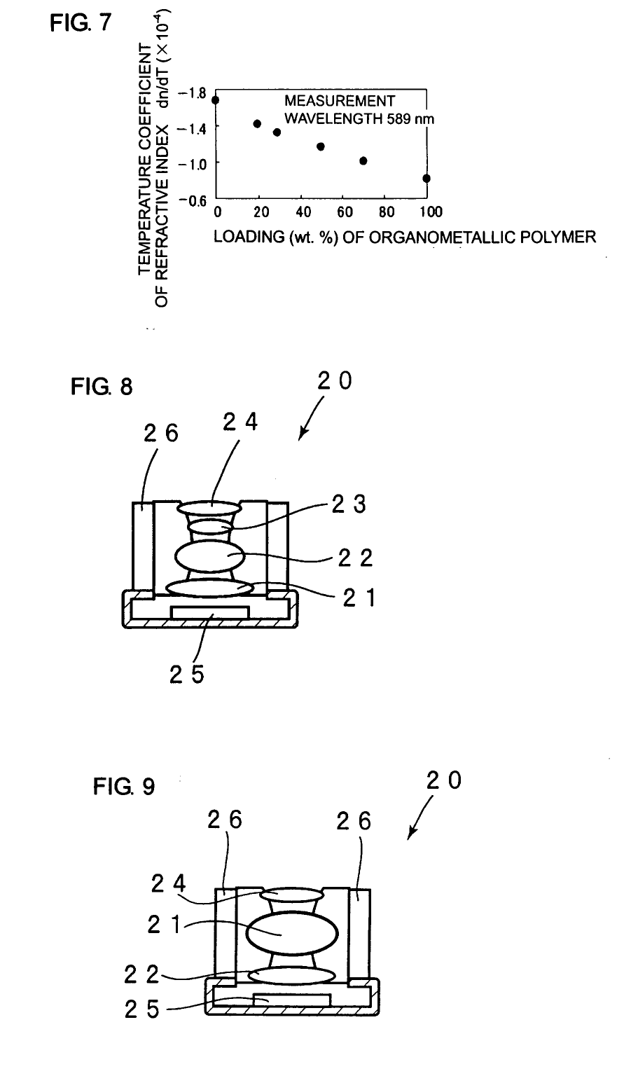

FIG. 7 is a graph which shows a relation of the loading of the organometallic polymer to the temperature coefficient of refractive index of the cured composition in Example 1. As shown in FIG. 7, the temperature coefficient of refractive index decreases with the increasing loading of the organometallic polymer.

This is believed due to the low temperature coefficient of refractive index that is about −0.8×10⁻⁴. In Comparative Example 1, the composition using pentaerithritol triacrylate in stead of the organometallic polymer, when cured, exhibits a temperature coefficient of refractive index of about −2.8×10⁻⁴.

(High-Temperature Test)

The compositions prepared in Example 1 and Comparative Example 1 were evaluated for shape stability in a high-temperature environment. A pellet-like sample, measuring about 2 mm in thickness and about 6 mm in diameter, was prepared for each composition and then heated in a 120° C. oven for 48 hours to measure a reduction in thickness of the sample after application of heat. Since the material is reduced in thickness as a result of shrinkage at a high temperature of 12° C., a reduction of thickness is measured in this test. Evaluation results are shown in Table 1. In Table 1, a measurement result for the case where only the viscous liquid A in Example 1 was used, is also shown for a comparative purpose.

TABLE 1

| | Loading (wt. %) | | | | |
|---|---|---|---|---|---|
| | 20 | 29 | 50 | 70 | 100 |
| Ex. 1 | 3 μm | 1 μm | 1 μm | 1 μm | 0.8 μm |
| Comp. Ex. 1 | 6 μm | 8 μm | 12 μm | 15 μm | 20 μm |

| | |
|---|---|
| Viscous Liquid A | 5 μm |
| in Ex. 1 | |

As can be seen from Table 1, the composition of Example 1 shows a decreasing shrinkage with the increasing loading of the organometallic polymer. On the other hand, the composition of Comparative Example 1 shows an increasing shrinkage and thus decreasing shape stability at a high temperature, as the loading of pentaerithritol triacrylate increases.

### Example 2

The procedure of Example 1 was followed, with the exception that the organometallic polymer was loaded in the amount of 29% by weight and benzyl methacrylate was excluded from the viscous liquid A, to prepare a curable organometallic composition. This composition was cured to measure its volumetric cure shrinkage. Also, the refractive index, Abbe number and temperature coefficient of refractive index of the cured composition were measured.

The measurement revealed a volumetric cure shrinkage of about 5.1%, a refractive index of about 1.60, an Abbe number of about 28 and a temperature coefficient of refractive index of about −1.6×10⁻⁴.

### Comparative Example 2

In Example 1, trimethylolpropane triacrylate, instead of the organometallic polymer, was used. This resulted in the tendency of volumetric cure shrinkage to increase with the increasing loading of trimethylolpropane acrylate, as similar to Comparative Example 1.

### Comparative Example 3

In the preparation of the viscous liquid B in Example 1, the organometallic compound B having a phenyl group was excluded and the organometallic compound A alone was used in the amount of 20.8 ml. This viscous liquid B was mixed with the viscous liquid A in the same manner as in Example 1 to prepare a curable organometallic composition.

However, clouding occurred at the point when the viscous liquids A and B were mixed, resulting in the failure to obtain a transparent composition. This occurrence of clouding is very likely due to the absence of an aryl group in the organometallic polymer in the viscous liquid B that renders its affinity with the fluorene acrylate insufficient.

### Example 3

In Example 1, 3-mercaptopropyltrimethoxysilane was used as the organometallic compound A in the preparation of the viscous liquid B. Specifically, 9.8 ml of this organometallic compound A, 6.3 ml of the organometallic compound B, 3.8 ml of the conc. 2N hydrochloric acid and 40 ml of ethanol were mixed and then allowed to stand for 24 hours, during which time the organometallic compound A and the organometallic compound B were hydrolyzed and polycondensed.

The resulting liquid containing a polycondensate was placed under nitrogen gas atmosphere and heated to 100° C. to remove, by evaporation, ethanol and methanol produced during the reaction. The resulting liquid serving as the viscous liquid B was mixed with the viscous liquid A so that the mixture contained the organometallic polymer in the amount of 29% by weight. As a result, a curable organometallic composition was prepared.

The obtained curable organometallic composition was cured in the same manner as described above to measure its volumetric cure shrinkage. In addition, the cured composition was measured for refractive index, Abbe number and temperature coefficient of refractive index.

The measurement revealed a volumetric cure shrinkage of about 6.4%, a refractive index of about 1.61, an Abbe number of about 28 and a temperature coefficient of refractive index of about −1.7×10⁻⁴.

### Example 4

In Example 1, the viscous liquid A was prepared without using benzyl methacrylate. This viscous liquid A was mixed with the viscous liquid B and trimethylolpropane triacrylate so that the mixture contained the organometallic polymer in the amount of 20% by weight and the trimethylolpropane triacrylate in the amount of 20% by weight. This resulted in the preparation of a curable organometallic composition.

The obtained curable organometallic composition was cured to measure its volumetric cure shrinkage. Also, the cured composition was measured for refractive index, Abbe number and temperature coefficient of refractive index.

The measurement revealed a volumetric cure shrinkage of about 7%, a refractive index of about 1.59, an Abbe number of about 30 and a temperature coefficient of refractive index of about −1.5×10⁻⁴.

### Example 5

Fine particles (mean particle diameter of 6 nm) of titanium oxide were dispersed in isopropyl alcohol to a concentration of about 10% by weight to prepare a dispersion. This particle dispersion was added to the viscous liquid B in Example 1. Thereafter, the resultant was heat dried at 100° C. to remove isopropyl alcohol by evaporation. As a result, a viscous liquid D was obtained.

The viscous liquid D was blended with the viscous liquid A in Example in varied proportions. Each composition was photocured and then measured for refractive index and Abbe number.

The photocured composition, whose refractive index was adjusted to about 1.62 as a result of the selected loading of the dispersion, exhibited an Abbe number of about 26. The volumetric cure shrinkage was about 6.5%.

### Example 6

Fine particles (mean particle diameter of 10 nm) of niobium oxide were dispersed in ethanol to a concentration of about 10% by weight to prepare a dispersion. This particle dispersion was added with stirring to a mixture containing 1 g of the viscous liquid B in Example 1 and 0.2 g of pentaerithritol triacrylate. The resultant was then heat dried at 100° C. to remove ethanol by evaporation. As a result, a viscous liquid E was obtained.

The viscous liquid E was blended with the viscous liquid A in Example in varied proportions, as similar to Example 1. Each composition was photocured and measured for refractive index and Abbe number.

The photocured composition, whose refractive index was adjusted to about 1.64 as a result of the selected loading of the dispersion, exhibited an Abbe number of about 24. The volumetric cure shrinkage was about 7%.

### Example 7

A composite aspherical lens was fabricated using the viscous liquid C in Example 1. The composite aspherical lens refers to an aspherical lens which uses, as a base, a spherical lens or flat plate made of glass or resin and has an aspherical resin layer formed on an optical plane of the base.

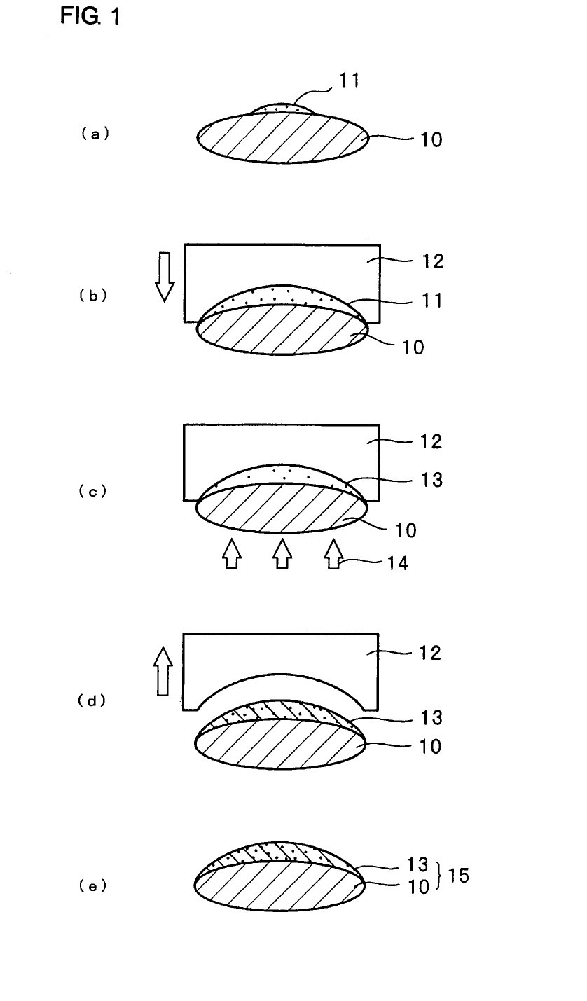

As shown in FIG. 1(a), a viscous liquid 11 was dripped over a glass spherical lens 10 (base glass) having a diameter of 5 mm and a maximum thickness of 1 mm. This viscous liquid 11 is the viscous liquid C used in Example 1. Next, a nickel mold 12 having an inner aspherical surface was pressed against the viscous liquid 11 on the glass spherical lens 10, as shown in FIG. 1(b). The viscous liquid 11 was then exposed through the glass spherical lens 10 to an ultraviolet radiation 14 so that the viscous liquid 11 was cured to form a resin layer 13 consisting of an organometallic polymer material, as shown in FIG. 1(c).

Subsequently, the mold 12 was moved away, as shown in FIG. 1(d), to obtain a composite aspherical lens 15 comprising the glass spherical lens 10 and the resin layer 13, as shown in FIG. 1(e).

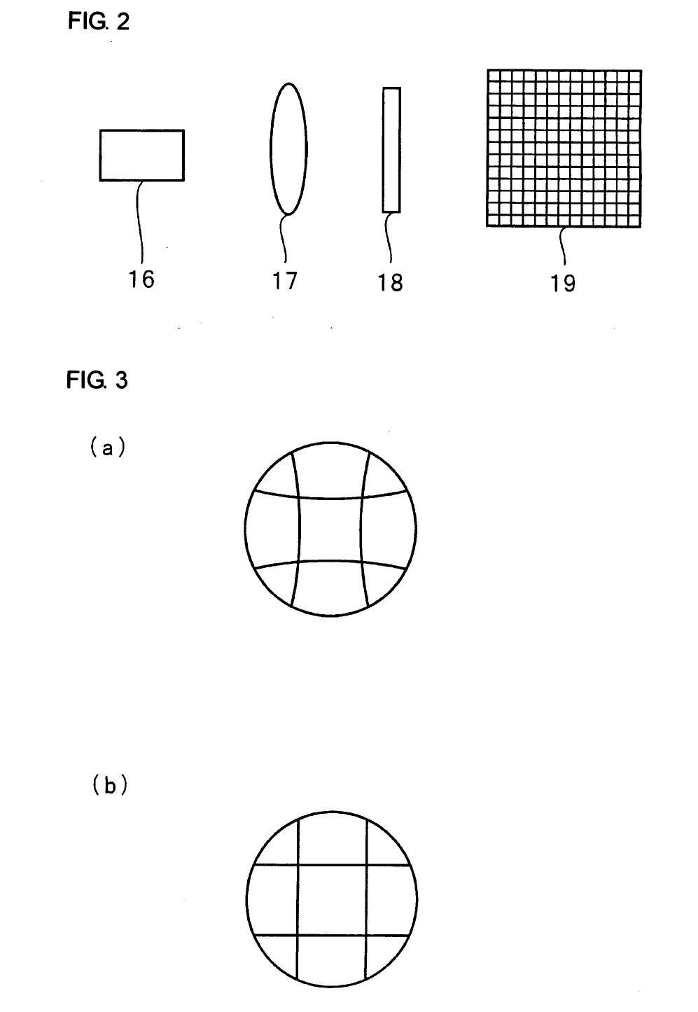

Next, the apparatus shown in FIG. 2 was utilized to observe spherical aberration for the composite aspherical lens and the spherical lens carrying no resin layer. A lens 17 was located between a screen 18 having a mesh pattern and a CCD camera 16. A magnified image of the mesh pattern on the screen 18 was observed using the CCD camera 16. This mesh pattern on the screen 18 is shown in FIG. 2 as being a mesh pattern 19 having a 0.5 nm interval.

In the case where the glass spherical lens 10 was used for the lens 17, a distorted image of the mesh pattern due to the spherical aberration unique to the spherical lens, as shown in FIG. 3(b), was observed. On the other hand, in the case where the above-fabricated composite aspherical lens 15 was used for the lens 17, a magnified true image of the mesh pattern was obtained, as shown in FIG. 3(a).

The same results were obtained when the viscous liquids in Examples other than Example 1 were used to fabricate the composite aspherical lens in the same manner as described above.

### Example 8

(Use of High-Refractive Translucent Ceramic Base)

The procedure of Example 7 was followed, with the exception that a high-refractive translucent ceramic (refractive index of about 2.1) was used as a base, to fabricate a composite aspherical lens.

The obtained composite aspherical lens was evaluated. In the evaluation, a magnified true image of the mesh pattern was obtained, as similar to Example 7.

### Example 9

The procedure of Example 7 was followed, with the exception that a high-refractive glass (product of Ohara Inc., product name “S-LAH79”, refractive index of about 2.0) was used as a base, to fabricate a composite aspherical lens.

The obtained composite aspherical lens was evaluated. In the evaluation, a magnified true image of the mesh pattern was obtained, as similar to Example 7.

The same results were obtained when other Ohara products under the designations of “S-NPH1” (refractive index of about 1.81), “S-NPH2” (refractive index of about 1.92), “S-TIH53” (refractive index of about 1.85), “S-TIH6” (refractive index of about 1.80) and “S-LAL7” (refractive index of about 1.65) were used.

### Example 10

FIG. 8 is a sectional view which shows an exemplary construction of a conventional camera module. As shown in FIG. 8, two plastic aspherical lenses 21 and 22 and two glass spherical lenses 23 and 24 are located above an image pickup element 25. These lenses are held in positions by an auto-focus mechanism 26. A camera module 20 is the one which includes those four lenses 21-24 and can be used as a 2-5 megapixel camera module for a mobile telephone. A selected combination of plural lenses assures a necessary magnification and achieves correction for various aberrations, including chromatic aberration that is inevitably generated in a lens for shooting camera. For example, in the construction shown in FIG. 8, chromatic aberrations are offset by a design which increases an Abbe number of at least one of the spherical lenses 23 and 24 and reduces an Abbe number of at least one of the plastic aspherical lenses 21 and 22.

FIG. 9 is a sectional view which shows an embodiment of a camera module in accordance with the present invention. In FIG. 9, the use of the composite aspherical lens (refractive index of the resin layer: about 1.59, Abbe number: about 30) of the present invention in place of at least one of the lenses 23 and 24 shown in FIG. 8 allows correction for chromatic aberration due to the resin layer having a low Abbe number and at least one of the plastic aspherical lenses 21 and 22, and accordingly permits elimination of one lens. As a result, a height of the camera module can be reduced by about 1 mm. The conventional camera module shown in FIG. 8 has a height of about 10 mm, while the camera module of this Example in accordance with the present invention, shown in FIG. 9, has a height of about 9 mm.

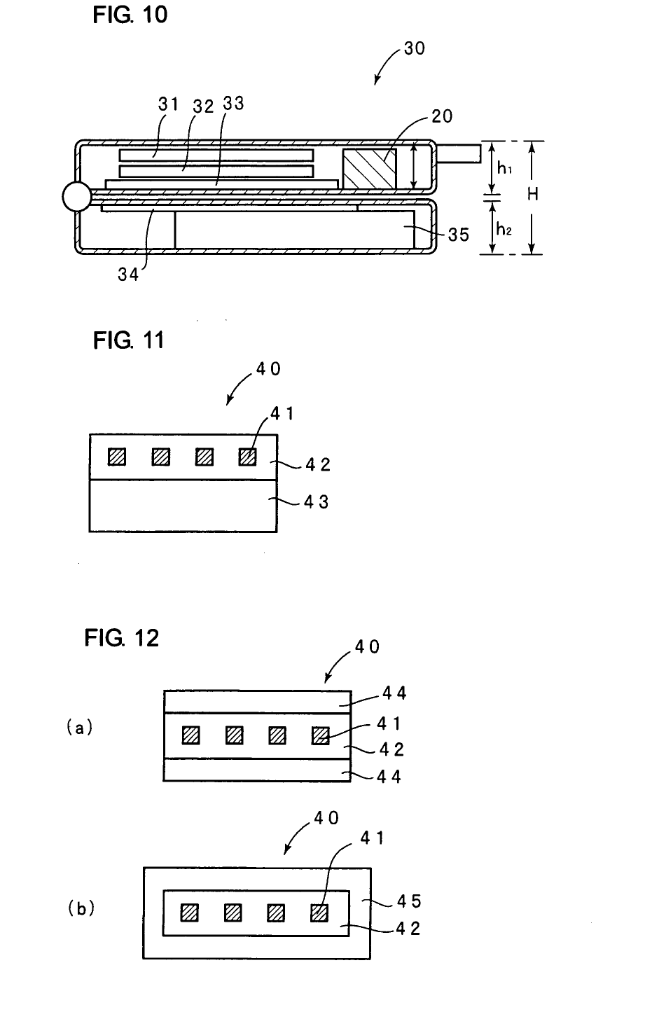

FIG. 10 is a sectional view which shows a folding mobile telephone incorporating a camera module. The camera module 20, together with a TV tuner 31, a hard disk drive 32 and a display 33, are located inside an upper section of the telephone. Located inside its lower section are a keyboard 34 and a battery 35.

In the case where a conventional camera module is used for the camera module 20, a height h₁ of its upper section is 12.5 mm and equal to a height h₂ of its lower section. Hence, an overall height H of the mobile telephone is 25 mm. However, the use of the camera module of this Example in accordance with the present invention, shown in FIG. 9, permits reduction of the height h₁ and accordingly the overall height H by about 1 mm.

Although the composite aspherical lens is shown in this particular embodiment as having the resin layer formed on the glass lens, the resin layer may be formed on a plastic lens in the present invention. In this case, the plastic lens may be made from a polyolefin resin such as the Nippon Zeon product “Zeonex resin” or the JSR product “Arton resin”, or a fluorene based polyester resin such as the Osaka Gas Chemical product “OKP-4”. Other useful resins include acrylic resins, epoxy resins, silicone resins, polycarbonate, polyethylene terephthalate, polyethylene naphthalate, fluororesins, polymethylpentene, polystyrene, polyarylate, polysulfone, polyether sulfone and polyether imide.

### Example 11

The camera module shown in FIG. 9 is also useful as a camera module of a back monitor for use in cars. The camera module for use in cars requires high heat resistance. The aspherical lens of Example 9 meets this requirement and also widens an angle of visual field due to its high refractive index.

### Example 12

The organometallic polymer material of the present invention is useful for intraboard and interboard connections in various electronic devices and can be applied to optical waveguide devices.

FIG. 11 is a sectional view which shows an embodiment of an optical waveguide in accordance with the present invention. As shown in FIG. 11, a cladding layer 42 is provided on a glass base 43. Core layers 41 are formed inside the cladding layer 42. Those core layers 41 are about 70 μm in height and arranged at intervals of about 500 μm. The cladding layer 42 has an about 100 μm thick upper portion overlying the core layers 41 and an about 100 μm thick lower portion underlying the core layers 41.

In this Example, the core layers 41 are formed using the curable organometallic composition which has been tailored such that it, when converted to a solid form by photocuring, exhibits a refractive index of about 1.53. The cladding layer 42 is formed using the curable organometallic composition which has been tailored such that it, when converted to a solid form by photocuring, exhibits a refractive index of about 1.51. Each core layer 41 has an about 70 μm square section. The glass base 43 comprises a 1 mm thick Tenpax glass.

A light having a wavelength of 650 nm, 830 nm or 850 nm was allowed to enter the optical waveguide from its one end and confirmed to exit from the other end of the optical waveguide. The optical propagation loss measurement using the cutback technique revealed a value of not exceeding 0.5 dB/cm.

FIG. 12(a) is a view which shows an optical waveguide having a structure wherein the core layers 41 and the cladding layer 42 are interposed between flexible substrates in the form of 70 μm thick polyimide films 44.

FIG. 12(b) is a sectional view which shows an optical waveguide having a 70 μm thick, polyimide mold layer 45 that surrounds the cladding layer 42.

The use of flexible substrates, as shown in FIGS. 12(a) and 12(b), enabled the optical waveguide to bend to a radius of curvature of about 10 mm, for example.

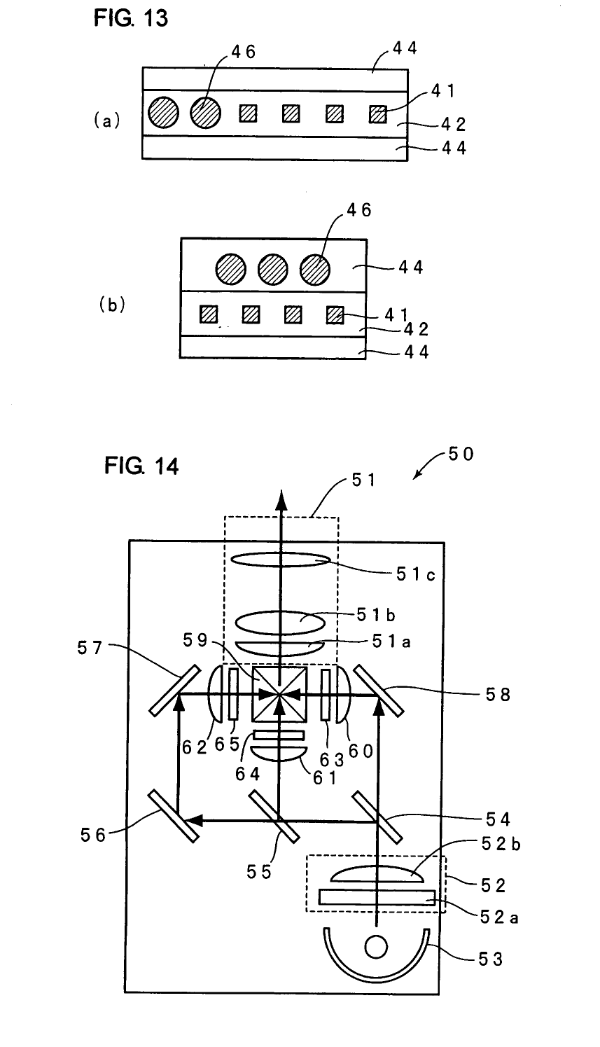

FIG. 13 is a sectional view which shows another embodiment of an optical waveguide in accordance with the present invention.

In FIG. 13(a), electrical power copper wires 46 each having a diameter of 150 mm are located alongside the core layers 41. The cladding layer 42 is interposed between flexible substrates in the form of 70 μm thick polyimide films 44.

In the embodiment shown in FIG. 13(b), those electrical power copper wires 46 are located inside the upper polyimide film 44.

As shown in FIG. 13, the optical waveguide of the present invention may include an electrical power wire. Such provision of electrical power wires permits simultaneous supply of an information signal and a power by a single element.

The electrical power wire 46 may have a section of a rectangular shape.

### Example 13

FIG. 14 is a schematic sectional view which shows a liquid crystal projector. An illumination optical system 52 is located above a light source 53. This illumination optical system 52 comprises lenses 52a and 52b. A light emitted from the light source 53 strikes a half mirror 54. The light transmitted through the half mirror 54 reflects at a mirror 58 and then passes through a lens 60 and a liquid crystal panel 63 to enter a cross prism 59.

On the other hand, the light reflected at the half mirror 54 is directed to a half mirror 55. The light reflected at the half mirror 55 passes through a lens 61 and a liquid crystal panel 64 to enter the cross prism 59.

The light transmitted through the half mirror 55 is reflected at a mirror 56 and then at a mirror 57. The reflected light passes through a lens 62 and a liquid crystal panel 65 to enter the cross prism 59.

The liquid crystal panel 65 is a liquid crystal panel for red (R). The liquid crystal panel 64 is a liquid crystal panel for green (G) and the liquid crystal panel 63 is a liquid crystal panel for blue (B). The lights passing through these liquid crystal panels are composed at the cross prism 59 and then allowed to pass through the projection optical system 51 and exit to an outside. The projection optical system 51 comprises lenses 51a, 51b and 51c.

The light source 53 may comprise a metal halide lamp, mercury lamps, LED, or the like.

Because the light source 53 is a source of heat, it has been conventionally required that the lenses 51a-51c of the projection optical system 51 should be spaced a certain distance from the light source 53.

However, the optical component of the present invention can be located closer to the light source 53 because it is formed of the organometallic polymer material having good heat resistance as described above.

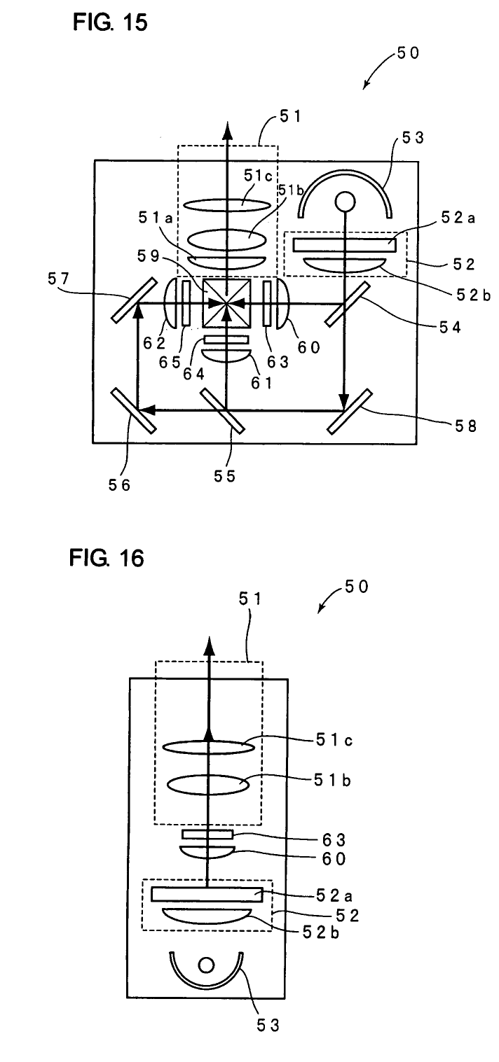

FIG. 15 is a schematic sectional view which shows an embodiment of a liquid crystal projector in accordance with the present invention.

In the embodiment shown in FIG. 15, the lens of Example 9 is used for the lenses 51a-51c of the projection optical system 51. Accordingly, the light source 53 can be located closer to the projection optical system 51, as shown in FIG. 15. This permits reduction in size of the liquid crystal projector 50.

In the liquid crystal projector shown in FIG. 15, a light emitted from the light source 53 passes through the illumination optical system 52 and then strikes the half mirror 54. The light reflected at the half mirror 54 passes through the lens 60 and the liquid crystal panel 63 to enter the cross prism 59. The light transmitted through the half mirror 54 is reflected at the mirror 58 to direct toward the half mirror 55. The light reflected at the half mirror 55 passes through the lens 61 and the liquid crystal panel 64 to enter the cross prism 59. The light transmitted through the half mirror 55 is reflected at the mirror 56 and then at the mirror 57. The reflected light passes through the lens 62 and the liquid crystal panel 65 to enter the cross prism 59. The lights transmitted through these liquid crystal panels 63, 64 and 65 are composed at the cross prism 59 and then allowed to pass through the projection optical system 51 and exit to an outside.

The liquid crystal projectors shown in FIGS. 14 and 15 are of the three-panel transmission type that utilizes three independent liquid crystal panels for RGB. However, the same results can be obtained with the use of a projector of the single-panel transmission type that utilizes a single liquid crystal panel for composite RGB.

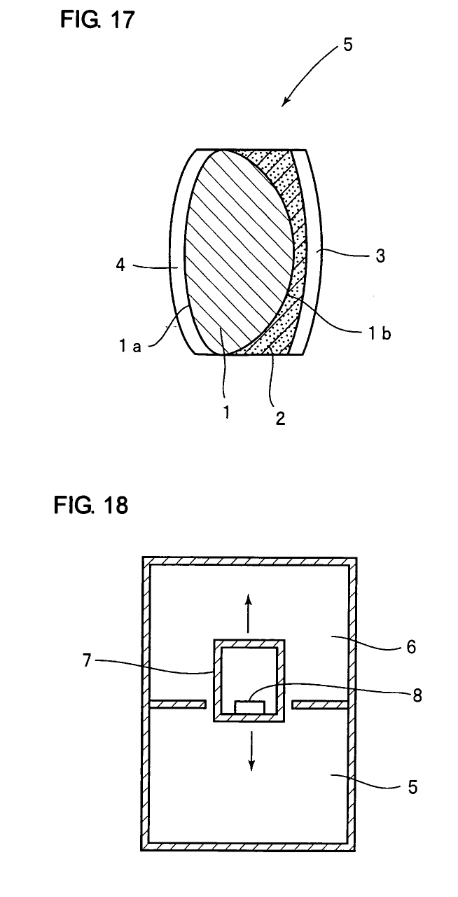

The liquid crystal projector shown in FIG. 16 uses a white LED for the light source 53 in order to achieve further size reduction. As shown in FIG. 16, a light emitted from the light source 53 is passed through the illumination optical system 52, the lens 60, the liquid crystal panel 63 and the projection optical system 51 to an outside.

As shown in FIG. 16, the light source 53, projection optical system 51 and the others between them may be arranged on a linear line. In this case, if the lenses 51a, 51b and 51c of the projection optical system 51 each comprises the lens of Example 25, a focal length can be reduced. As a result, an overall length of the crystal liquid projector can be reduced.

### Example 14

A composite aspherical lens shown in FIG. 17 was fabricated. The composite aspherical lens 5 shown in FIG. 17 has a lens base 1 having a diameter of 3 mm and a maximum thickness of 1.5 mm, a resin layer 2 formed on a second surface 1b of the lens base 1 and comprising the organometallic polymer material of the present invention, and an AR (antireflection) film 3 formed on the resin layer 2. Another AR film 4 is formed on a first surface 1a of the lens base 1. The first surface 1a of the base lens 1 has a radius of curvature of 4 mm. The second surface 1b has a radius of curvature of 1.7 mm.

The organometallic polymer material forming the resin layer 2 was made from a curable organometallic composition containing 40% by weight of fluorene acrylate, 40% by weight of an organometallic polymer and 20% by weight of phenoxyethyl acrylate (PhEA). The organometallic polymer comprises a mixture of 3-methacryloxypropyltriethoxysilane (MPTES) and diphenyldimethoxysilane (DPhDMS) at a 50:50 ratio by mole.

Specifically, a viscous liquid A and a viscous liquid B were separately prepared according to the following respective procedures and then mixed while heated at 60° C. to prepare the curable organometallic composition.

(Viscous Liquid A)

6.4 g of fluorene acrylate, 0.2 g of 1-hydroxy-cyclohexyl-phenylketone, 0.05 g of HALS (Tinuvin 292, product of Chiba Specialty Chemicals Inc.), 0.15 g of a UV absorber (Tinuvin 400, product of Chiba Specialty Chemicals Inc.) and 3.2 g of PhEA were mixed while heated at 60° C. to prepare the viscous liquid A.

(Viscous Liquid B)

12.3 ml of MPTES, 10.3 ml of DPhDMS, 3.8 ml of an aqueous solution containing hydrochloric acid (2N conc. hydrochloric acid) as a reaction catalyst and 40 ml of ethanol were mixed and then left to stand for 24 hours to effect hydrolysis and polycondensation.

The resulting liquid containing a polycondensate was placed under nitrogen atmosphere and heated to 100° C. to remove ethanol by evaporation. As a result, a viscous liquid was obtained. 1 g of this viscous liquid was collected and mixed with 3 ml of a metal alkoxide X in the form of trimethyl-ethoxysilane and 0.8 ml of an organic acid Y in the form of trifluoroacetican hydride. The resulting mixture was left to stand for 24 hours, placed under nitrogen atmosphere and then heat dried at 110° C. to remove excess metal alkoxide X and organic acid Y by evaporation. As a result, the viscous liquid B was obtained.

This viscous liquid B was used in Examples described hereinafter.

The curable organometallic compound obtained in the way described above was dripped over the lens base to form the resin layer 2.

Next, the AR films 3 and 4 were formed on the resin layer 2 and the lens base 1, respectively. The AR film was formed by depositing silicon oxide films alternatingly with titanium oxide films by an electron beam deposition method. A design wavelength λ was 500 nm. First, a silicon oxide film as an undercoating layer was deposited on the base to a thickness of λ, followed by depositing a 0.04λ thick titanium oxide film, a 0.1λ thick silicon oxide film, a 0.5λ thick titanium oxide film and a 0.24λ thick silicon oxide film, in the sequence from the side of the base, according to the disclosure of Japanese Patent Laid-Open No. Hei 6-11601.

Two types of composite aspherical lenses were fabricated with the respective use of a glass base and a plastic base.

The Ohara product S-FPL 51 was used for the glass base. The plastic base was made from the Zeonex resin manufactured by Nippon Zeon Co., Ltd. In case of using the glass base, the radius of curvature of the resin layer 2 was set at 3.01 mm. In case of using the plastic base, the radius of curvature of the resin layer 2 was set at 4.43 mm.

(Thermal Shock Test)

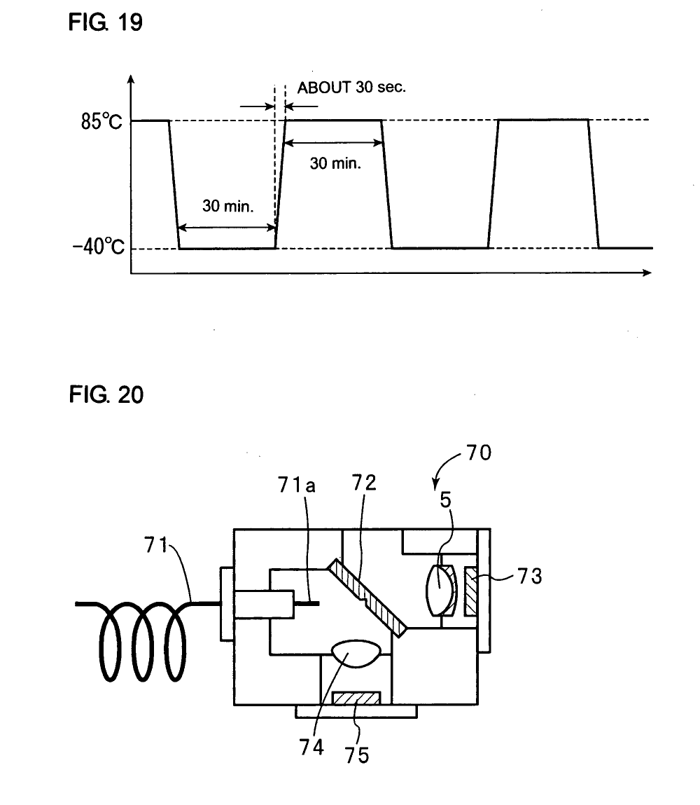

The above-fabricated two types of composite aspherical lenses were subjected to a thermal shock test. FIG. 18 is a schematic sectional view which shows an apparatus by which the thermal shock test was performed. A sample 8, a measurement object, is placed in a container 7. The thermal shock is given to the sample 8 by cyclic movement of this container 7 at the intervals shown in FIG. 19 between a constant-temperature chamber 5 at 85° C. and a constant-temperature chamber 6 at −40° C.

As a result of the thermal shock test on the composite aspherical lens using the glass base, neither separation nor cracking occurred in the resin layer and the AR film after 500 cycles. However, in the test on the composite aspherical lens using the plastic base, cracking occurred in the AR film after 100 cycles.

The curable organometallic composition of Example 1 (containing the organometallic polymer in the amount of 20% by weight) was utilized to fabricate two types of composite aspherical lenses using the glass and plastic bases and subject them to the thermal test in the same manner as described above. As a result of the test, cracking occurred in the resin layer and the AR film after 100 cycles, for either of the composite aspherical lenses using the glass base and the plastic base. This demonstrates that the phenoxyethyl acrylate (PhEA) used in this Example is more effective than the benzyl methacrylate (BzMA) used in Example 1 in preventing the occurrence of cracking. In case of using PhEA for the acrylate, it is preferably contained in the range of 10-30% by weight.

### Example 15

Using pentaerithritol triacrylate (PETA) for the acrylate, a curable organometallic composition was prepared containing 55% by weight of fluorene acrylate, 25% by weight of an organometallic polymer and 15% by weight of PETA.

Specifically, a viscous liquid A prepared according to the following procedure and the viscous liquid B of Example 14 were mixed with stirring while heated at 60° C. to prepare the curable organometallic composition.

(Viscous Liquid A)

8.8 g of fluorene acrylate, 0.2 g of 1-hydroxy-cyclohexyl-phenylketone, 0.05 g of HALS (Tinuvin 292, product of Chiba Specialty Chemicals Inc.), 0.15 g of a UV absorber (Tinuvin 400, product of Chiba Specialty Chemicals Inc.) and 4 g of PETA were mixed while heated at 60° C. to prepare the viscous liquid A.

The above-prepared curable organometallic composition was utilized to fabricate two types of composite aspherical lenses using the glass base and the plastic base and subject them to the thermal test in the same manner as in Example 14.

In the thermal shock test on the composite aspherical lens using the plastic base, neither separation nor cracking occurred in the resin layer and the AR film after 500 cycles. However, in the test on the composite aspherical lens using the glass base, cracking occurred in either of the resin layer and the AR film within 100 cycles. Where PETA is used for the acrylate, it is preferably contained in the range of 5-25% by weight.

### Example 16

Using the PETA and a urethane acrylate (Daicel-Cytec product “Ebecryl 210”) for the acrylate, a curable organo-metallic composition was prepared containing 45% by weight of fluorene acrylate, 30% by weight of an organometallic polymer, 10% by weight of PETA and 15% by weight of the urethane acrylate.

The viscous liquid A was prepared according to the following procedure.

(Viscous Liquid A)

7.2 g of fluorene acrylate, 0.2 g of 1-hydroxy-cyclohexyl-phenylketone, 0.05 g of HALS (Tinuvin 292, product of Chiba Specialty Chemicals Inc.), 0.15 g of a UV absorber (Tinuvin 400, product of Chiba Specialty Chemicals Inc.), 1.6 g of PETA and 2.4 g of the urethane acrylate were mixed while heated at 60° C. to obtain the viscous liquid A.

The above-prepared curable organometallic composition was utilized to fabricate two types of composite aspherical lenses using the glass base and the plastic base and subject them to the thermal test in the same manner as in Example 14.

Neither separation nor cracking occurred in the resin layer and the AR film after 100 cycles, for either of the composite aspherical lenses using the glass base and the plastic base.

However, the curable organometallic composition was slightly high in viscosity. Also, in the test on the composite aspherical lens using the glass base, cracking occurred in the resin layer after 250 cycles. Where urethane acrylate is used for the acrylate, it is preferably contained in the range of 5-10% by weight.

### Example 17

Using the PETA and an EO-modified bisphenol A diacrylate (To a Gosei product “M-210”) for the acrylate, a curable organometallic composition was prepared containing 45% by weight of fluorene acrylate, 35% by weight of an organometallic polymer, 10% by weight of PETA and 15% by weight of the bisphenol diacrylate.

The viscous liquid A was prepared according to the following procedure.

(Viscous Liquid A)

7.2 g of fluorene acrylate, 0.2 g of 1-hydroxy-cyclohexyl-phenylketone, 0.05 g of HALS (Tinuvin 292, product of Chiba Specialty Chemicals Inc.), 0.15 g of a U absorber (Tinuvin 400, product of Chiba Specialty Chemicals Inc.), 1.6 g of PETA and 1.6 g of the bisphenol diacrylate were mixed while heated at 60′ to obtain the viscous liquid A.

The obtained curable organometallic composition was utilized to fabricate two types of composite aspherical lenses using the glass base and the plastic base and subject them to the thermal test in the same manner as in Example 14.

In the test on the composite aspherical lens using the plastic base, neither separation nor cracking occurred in the resin layer and the AR film after 500 cycles. On the other hand, in the test on the composite aspherical lens using the glass base, cracking occurred in both the resin layer and the AR film after 100 cycles. A viscosity of the curable organometallic composition in this Example was slightly lower than that in Example 16.

Although the EO-modified bisphenol diacrylate is used in this Example, others such as PO-modified bisphenol diacrylate and tetramethylene oxide-modified bisphenol diacrylate are also useful. Other (meth)acrylates having a bisphenol group and a (meth)acryl group, such as bisphenol F diacrylate, are also useful. Where such bisphenol diacrylate is used for the acrylate, it is preferably contained in the range of 15-40% by weight.

### Example 18

Using the PETA and a hydroxyethylated o-phenylphenol methacrylate (Shin-Nakamura Chemical product “NK Ester L-4”) (PhPhMA) for the acrylate, a curable organometallic composition was prepared containing 40% by weight of fluorene acrylate, 20% by weight of an organometallic polymer, 10% by weight of PETA and 30% by weight of the PhPhMA.

The viscous liquid A was prepared according to the following procedure.

(Viscous Liquid A)

7.2 g of fluorene acrylate, 0.2 g of 1-hydroxy-cyclohexyl-phenylketone, 0.05 g of HALS (Tinuvin 292, product of Chiba Specialty Chemicals Inc.), 0.15 g of a UV absorber (Tinuvin 400, product of Chiba Specialty Chemicals Inc.), 1.6 g of PETA and 4.8 g of the PhPhMA were mixed while heated at 60° C. to obtain the viscous liquid A.

The obtained curable organometallic composition was utilized to fabricate two types of composite aspherical lenses using the glass base and the plastic base and subject them to the thermal test in the same manner as in Example 14.

In the test on the composite aspherical lens using the plastic base, neither separation nor cracking occurred in the resin layer and the AR film after 500 cycles. However, in the test on the composite aspherical lens using the glass base, cracking occurred in both the resin layer and the AR film after 100 cycles.

A viscosity of the curable organometallic composition in this Example was slightly lower than that in Example 16.

In this Example, the hydroxyethylated o-phenylphenol methacrylate is used. Alternatively, a (meth)acrylate having a phenylphenol group and a (meth)acryl group, such as o-phenylphenolglycidyl ether acrylate (Shin-Nakamura Chemical product “NK Ester 401B”) can be used. Where such phenylphenol (meth)acrylate is used for the acrylate, it is preferably contained in the range of 10-40% by weight.

As evident from the forgoing, diluting the curable organometallic composition with the (meth) acrylate having two or more phenyl groups, such as a bisphenol or phenylphenol group in Example 17 or 18, reduces a viscosity of the curable organometallic composition while maintaining its high refractive index.

Viscosities of the curable organometallic compositions prepared in Examples 1 and 14-18, as well as refractive indexes and Abbe numbers of those compositions after cured, are shown in Table 2.

TABLE 2

| | Organo- | Fluorene- | | | | | |
|---|---|---|---|---|---|---|---|
| | metallic | based | First | Second | | Refractive | Abbe |
| | Polymer | Compound | Acrylate | Acrylate | Viscosity | Index | Number |
| Ex. 1 | MPTES + | Fluorene | BzMA | None | Low | 1.600 | 28 |
| Ex. 14 | DPhDMS | Acrylate | PhEA | None | Low | 1.589 | 30 |
| Ex. 15 | | | PETA | None | Moderate | 1.582 | 32 |
| Ex. 16 | | | PETA | Urethane | High | 1.591 | 29 |
| | | | | Acrylate | | | |
| Ex. 17 | | | PETA | Bisphenol | Low | 1.588 | 30 |
| | | | | Acrylate | | | |
| Ex. 18 | | | PETA | PhPhMA | Low | 1.594 | 29 |

BzMA, PhEA, PhPhMA are monofunctional acrylates, urethane acrylate and bisphenol acrylate are bifunctional acrylates, and PETA is a trifunctional acrylate.

### Example 19

A focal length of the composite aspherical lens fabricated using the glass base in Example 14 was measured to be 3.79 mm for both wavelengths of 486 nm and 656 nm.

### Example 20

A focal length of the composite aspherical lens fabricated using the plastic base in Example 17 was measured to be 4.92 mm for both wavelengths of 486 nm and 656 nm.

In Examples 19 and 20, elimination of chromatic aberration was achieved through the use of a single composite aspherical lens. Needless to say, such removal of chromatic aberration can also be achieved through the use of a lens system comprising a combination of plural lenses, at least one of which has a resin layer formed from the curable organometallic composition of the present invention.

### Example 21

FIG. 20 is a schematic sectional view which shows an optical transmitter and receiver module using the composite aspherical lens 5 as one embodiment of the optical component of the present invention.

One end 71a of an optical fiber 71 is inserted in an optical transmitter and receiver module 70 which encloses a light-emitting element 73 in a position opposing to the one end 71a of the optical fiber 71. The composite aspherical lens 5 in accordance with the present invention is located forwardly of the light-emitting element 73. A wavelength selection filter 72 is located between the composite aspherical lens 5 and the one end 71a of the optical fiber 71 and set at an angle of 45 degrees. A light-receiving element 75 is located below the wavelength selection filter 72, with a lens 74 being positioned between them.

A light emitted from the light-emitting element 73 is passed through the composite aspherical lens 5 and then the wavelength selection filter 72 to enter the optical fiber 71 through its one end 71a for transmission.

A light transferred from the optical fiber 71 exits from the one end 71a, reflects at the wavelength selection filter 72, passes through the lens 74 and is then received by the light-receiving element 75.

Because the optical transmitter and receiver module uses the composite aspherical lens 5 in accordance with the present invention, its focal length can be shortened and thus reduced in size.

What is claimed is:

1. A curable organometallic composition characterized in that it contains an organometallic polymer having an -M-O-M- bond (M denotes a metal atom) and an aryl group, and a fluorene-based compound having an acryloyl or methacryloyl group.

2. The curable organometallic composition as recited in claim 1, characterized in that it further contains an (meth)acrylate having two or more functional groups.

3. The curable organometallic composition as recited in claim 1, characterized in that it further contains an (meth)acrylate having one or more aryl groups.

4. The curable organometallic composition as recited in claim 2, characterized in that it further contains an aromatic urethane acrylate oligomer.

5. The curable organometallic composition as recited in claim 1, characterized in that it further contains a metal alkoxide having only one hydrolyzable group and/or its hydrolysate.

6. The curable organometallic composition as recited in claim 1, characterized in that it further contains an organic acid anhydride and/or organic acid.

7. The curable organometallic composition as recited in claim 1, characterized in that said metal atom M in the organometallic polymer is at least one of Si, Nb, Ti and Zr.

8. An organometallic polymer material characterized in that it is obtained by polymerizing the curable organometallic composition as recited in claim 1.

9. An optical component characterized in that it has a light transmissive region formed using the organometallic polymer material as recited in claim 8.

10. The optical component as recited in claim 9, characterized in that it is a composite aspherical lens fabricated by forming said light transmissive region on a translucent member.

11. An optical device characterized in that it includes the optical component as recited in claim 9.
